(19) United States
(12) Patent Application Publication
(10) Pub. No.: US 2012/0072220 A1
(43) Pub. Date: Mar. 22, 2012

(54) Matching text sets

(75) Inventors: Xu Zhang, Hangzhou (CN); Ningjun Su, Hangzhou (CN); Haijie Gu, Hangzhou (CN); Jiancheng Qi, Hangzhou (CN)

(73) Assignee: Alibaba Group Holding Limited

(21) Appl. No.: 13/200,123

(22) Filed: Sep. 19, 2011

(30) Foreign Application Priority Data
Sep. 20, 2010 (CN) 201010290693.4

(51) Int. Cl. G10L 15/00

(52) U.S. Cl. 704/251; 704/E15.001

(57) ABSTRACT

Matching text sets is disclosed, including: extracting a text set from data associated with a current period; storing the text set with a plurality of text sets; extracting a keyword from the text set; determining a weight value associated with the keyword associated with the text set; determining a degree of similarity between the text set and another text set based at least in part on a weight value associated with the keyword associated with the text set and a weight value associated with a keyword associated with the other text set; and determining whether the text set is related to the other text set based at least in part on the determined degree of similarity.

### CROSS REFERENCE TO OTHER APPLICATIONS

This application claims priority to People's Republic of China Patent Application No. 201010290693.4 entitled A METHOD AND DEVICE OF MATCHING TEXT filed Sep. 20, 2010 which is incorporated herein by reference for all purposes.

### FIELD OF THE INVENTION

The present application relates to the field of data processing. In particular, it relates to matching text.

### BACKGROUND OF THE INVENTION

Conventionally, text comparison is generally carried out through full-quantity computation matching. To obtain the correlation between text, calculations need to be performed on all the acquired text so that a degree of similarity can be determined with respect to each pair of text sets in the body of acquired text data. Typically, such a process entails calculations on all of the text data, which can require significant amount of calculation time (e.g., the calculation time could be of the O(N̂2) order, where N is the number of text sets). Furthermore, the calculation time can increase as the number of text sets N increases.

Calculations involving such large amounts of data can have an adverse impact on equipment systems and place I/O communications, data storage, and data network transmissions under pressure and also slow the rate of data processing. Sometimes, blockages or congestion in data transmission can occur. In short, a large volume of data calculations involved in the conventional technique of performing full-quantity text matching can be inefficient and also consumes a lot resources.

To optimize content-based text matching, either or both of the following techniques are performed in some systems:

(1) For the single-machine version (i.e., non-distributed system) of content-based text matching, text matching speed and efficiency can be improved by building an index.

(2) For distributed content-based text matching, hardware support can be increased (e.g., by adding more redundant servers to process data in parallel) to improve text matching speed and efficiency.

However, neither an index nor by adding more parallel processing can effectively solve the problems of text matching processing a large volume of data. Therefore, a more efficient solution to performing text matching on a large volume of data is desirable.

### BRIEF DESCRIPTION OF THE DRAWINGS

Various embodiments of the invention are disclosed in the following detailed description and the accompanying drawings.

FIG. 1 shows a diagram of a system for matching text sets.

FIG. 2 is a flow diagram showing an embodiment of a process of matching text sets.

FIG. 3 is a flow diagram showing an embodiment of a process of matching text sets.

FIG. 4 is a flow diagram showing an embodiment of a process of filtering text sets.

FIG. 5A is a flow diagram showing an example of a process of matching text sets.

FIG. 5B is an example of an architecture with which process 500 can be implemented at least in part.

FIG. 6 is a flow diagram that shows examples of two techniques by which to obtain an updated word frequency table.

FIG. 7 is a diagram that shows an embodiment of a system for matching text sets.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique of matching text sets is disclosed. In various embodiments, content information are acquired and stored on a periodic basis. The text from the acquired content information is also extracted and stored (e.g. to one or more databases) as one or more text sets. As used herein, “original text” refers to text that was acquired and stored in a period before the current period. As used herein, “new text” refers to text that is acquired and stored in the current period. As used herein, “text” or “text set” can refer to any piece of text that is machine-readable (e.g., alphanumeric characters that are inputted via a computing device or text on paper that is recognized by a computer). In various embodiments, the text sets extracted during each period are accumulated in the same one or more databases such that the databases include both original text sets from a previous period and new text sets from the current period.

In various embodiments, the designation of an “original” and “new” text set is based on whether the text set was respectively acquired during a previous or the current period. As each current period ends and becomes referred to as a previous period and the next new/current period begins, the designations of the same text set, as used herein, changes from “new” to “original.” Nevertheless, the degree of similarity to be determined between a pair of text sets is based on the substance of each text set (e.g., one or more keywords extracted from the text set) and is not affected by whether the “new” or “original” designations of the text set because the designations change as a period ends and a new period begins. For example, when a new period begins, the “new” text sets from the most recent period are to be referred to as “original” text sets and the text sets obtained in the current, new period are referred as “new.”

The disclosed technique of matching text sets can be used to compare (e.g., every) two sets of text to determine a degree of similarity between the two. The two sets of text are retrieved from the same database(s) in which the text sets extracted over one or more periods are stored. The two sets of text can include one new text and one original text, two new sets of text, and two original sets of text.

In various embodiments, a word frequency table is updated periodically and is used to determine the degree of similarity between any two sets of text stored in the one or more databases.

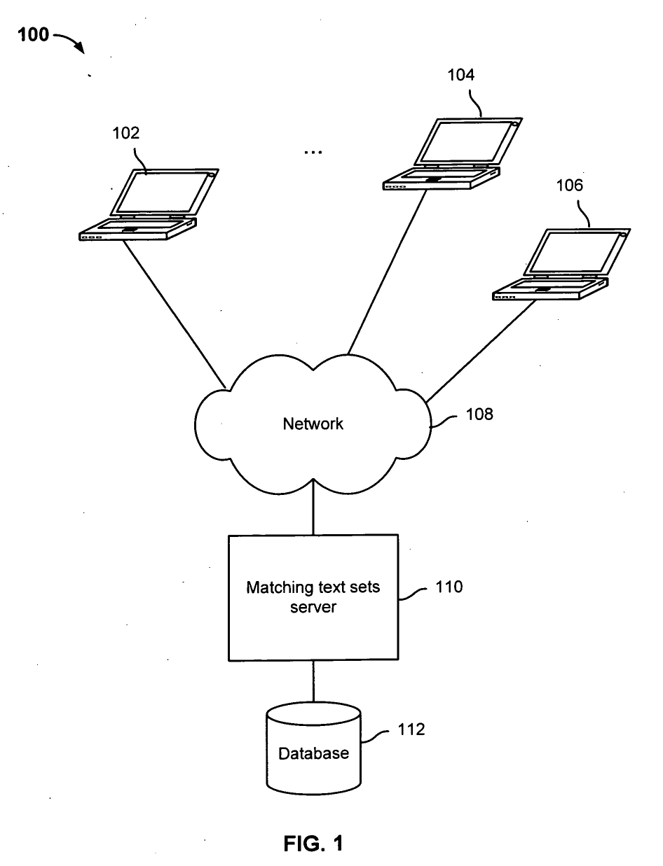

FIG. 1 shows a diagram of a system for matching text sets. System 100 includes devices 102, 104, 106, network 108, matching text sets server 110, and database 112. Network 108 can include various high speed data and/or telecommunications networks. In some embodiments, matching text sets server 110 is a component of and/or is associated with an electronic commerce website.

Devices 102, 104, and 106 each represents a user terminal in which a user can submit/publish content information. In some embodiments, the user can use one or more of devices 102, 104, or 106 to submit/publish content information; the content information can be product information that is submitted/published at the electronic commerce website. In various embodiments, the submitted/published content information is sent to matching text sets server 110. More than one user can submit/publish content information over each of devices 102, 104, and 106. Devices 102, 104, and 106 can each be, for example, a desktop computer, a laptop computer, a smart phone, a mobile device, a tablet device, or any other type of computing device. Each of devices 102, 104, and 106 can be configured to include a web browser application (e.g., Microsoft Internet Explorer™, Google Chrome™). While there are three devices shown in the example of system 100 to illustrate the idea that matching text sets server 110 can receive content information from one or more client devices, more or fewer devices can be included in a system such as system 100.

In some embodiments, a user can also use devices 102, 104, and/or 106 to browse the electronic commerce website and receive product recommendations in response to one or more user operations at the website. For example, the user can browse a webpage associated with a product and then receive one or more recommendations of other products (e.g., at a display associated with devices 102, 104, and/or 106). Such product recommendations can be generated based on the results of matching text sets, as will be discussed in further detail below.

Matching text sets server 110 is configured to obtain user-published content information from one or more devices (e.g., devices 102, 104, and 106). In various embodiments, matching text sets server 110 periodically obtains such information from the devices. Matching text sets server 110 is configured to extract the text sets (by ignoring the non-text based content such as images) of the obtained content information and store them to a database such as database 112 (database 112 can represent one or more than one databases). Text sets that are obtained during the current period are referred to as new text sets. Text sets that were obtained during a previous period are referred to as original text sets. In some embodiments, either new or original text sets are stored in the same database that is represented by database 112. Matching text sets server 110 is configured to determine which text sets of database 112 are related to each other (e.g., which two text sets match each other) based at least in part on first determining the degree of similarity between different pairs of sets of text that are stored in database 112, as is discussed in further detail below. In some embodiments, matching text server 110 is configured to provide the results of text matching to an electronic commerce website to facilitate in generating product recommendations.

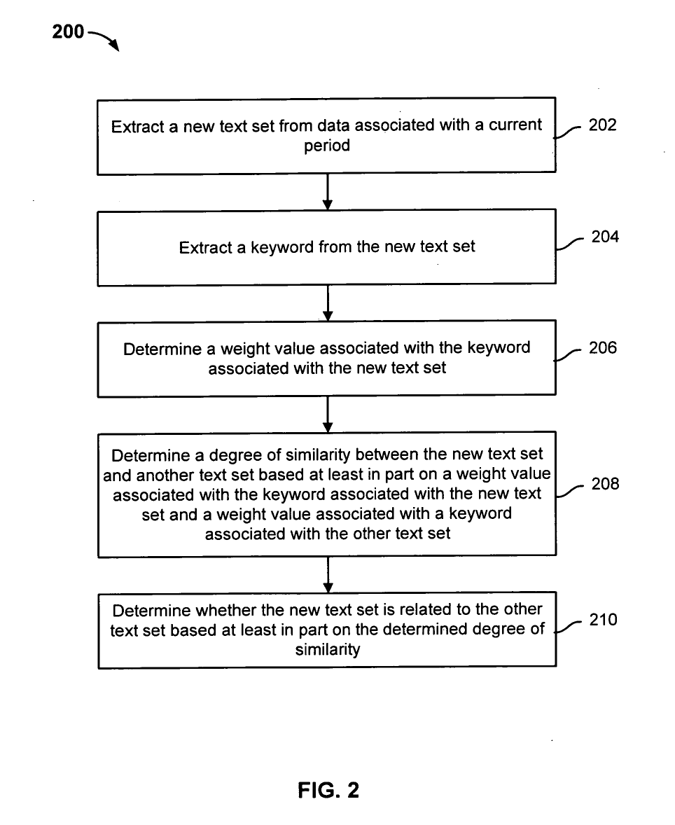

FIG. 2 is a flow diagram showing an embodiment of a process of matching text sets. In some embodiments, process 200 can be implemented on system 100. Process 200 can be used to determine a degree of similarity between a new text set and an original text set, or a new text set and another new text set.

At 202, a new text set is extracted from data associated with a current period.

Data such as user-published content information is acquired each period. The length of each period can be predetermined by a system administrator to be one day, one week, every several hours, for example. For example, user-published content information can include descriptions of/information about products (product information) that are available at an electronic commerce website that are submitted to the website by the sellers of the products. For example, to be able to publish product information at the website, a user (e.g., seller) might need to have an account with the website. For example, a user can publish product information that includes text and/or other content (e.g., images, interactive web elements).

For example, a user can publish product information through a (e.g., web browser) at a client device, and a server can periodically acquire product information published from each client device. In some embodiments, the acquired information is stored at one or more databases. For the published product information acquired during each period, the one or more sets of text can be separated from the non-text and stored in the same database or different databases. Because information is acquired every period and stored at the database(s), the database(s) can include text sets from one or more previous periods (original text sets) and also text sets from the current period (new text sets). In various embodiments, a text set that is extracted from a particular piece of content information can be stored with an association/identifier (e.g., identifier of the user, the time at which the information was published, the product, if any, with which the information is associated, whether the information was published in a prior/previous or current period) associated with that particular piece of content information. In some embodiment, the text set that is extracted from each piece of newly acquired content information can be considered as a new text set; so, for each current period, multiple new pieces of text (text sets) can be extracted from a corresponding number of pieces of content information.

In some embodiments, even before the one or more set of new text are extracted from the content information that is collected from the current period, the content information is filtered based on a predetermined filtering rule. For example, after published product information is obtained, product information that does not include one or more designated characters or words of the filter, e.g., images of a product, are filtered out (i.e., discarded) and not used for text matching. Filtering can reduce the volume of text sets on which matching is to be performed on and to exclude data that does not conform to the desired type of data (e.g., product information to be analyzed).

For example, assume that a piece of product information acquired from the current period is regarding a MP3 player. This piece of product information can include text such as Title: MP3, Color: Red, Model no.: 325, a description of features, and other relevant information such as images of the MP3 player. Then, the text set (“new text set”), such as the portion of the product information including Title: MP3, Color: Red, Model no.: 325, a description of features can be extracted and stored.

At 204, a keyword is extracted from the new text set.

Each new text set can be separated into individual words and keywords can be extracted from the set of individual words. In some embodiments, a keyword includes two or more individual words. Keywords are identified on the basis that they are useful in representing the particular piece of content information with which they are associated. In various embodiments, keywords can be identified and extracted from the set of individual words that are associated with the new text set based on a set of predetermined rules. For example, the predetermined rules can include a list of words that are designated as keywords and/or a list of words to discard because they are unlikely to be important. The extracted keywords are to be used in matching text sets. In some embodiments, the keywords that are extracted from a particular piece of content information are stored in a word vector (or some other form of data structure) that is associated with that piece of content information.

For example, after the new text set that includes information such as Title: MP3, Color: Red, Model no.: XX, and a description of features is separated into individual words, the extracted keywords such as “MP3” and “red,” can be stored in a word vector.

At 206, a weight value associated with the keyword associated with the new text is determined.

In various embodiments, the weight value of a keyword can be determined based on a generated word frequency table.

In some embodiments, to generate the word frequency table, all text sets (e.g., from one or more previous periods) stored in the database(s) are analyzed (e.g., separated into individual words and the keywords are identified and counted) and the number of occurrences of each word (i.e., the frequency of each word) in each text set is stored in the table. In some embodiments, the word frequency table is updated each time one or more new text sets are obtained, or periodically. In various embodiments, by generating information on the frequency of each keyword included in each of the text sets that is currently stored at the database(s) for the word frequency table, the weight values of the keywords can be determined.

In various embodiments, at 206, a weight value is determined for each keyword that is stored in the database(s), including any keyword that is extracted from the new text set (acquired in the current period), and also any keyword that was extracted from any original text sets (that were acquired from a previous period).

In some embodiments, the word frequency table is periodically updated (e.g., after one or more new text sets are acquired, or after a certain amount of time) based on the frequency of every word (which includes keywords and non-keyword words extracted from the new texts) included in each text set that is stored in the database(s).

In some embodiments, this updating comprises two possible scenarios:

Scenario 1: A new word frequency table is generated based on all the text sets (e.g., stored across multiple periods) that are currently stored in the database.

After each time one or more new text sets are obtained, the frequency of each word (including keywords and non-keyword words) in each of the new text sets and in each of the original text sets stored in the database is counted to produce a new word frequency table that includes the frequency of each word that is included in each text set that is currently stored in the database(s). Because the calculation volume for calculating frequencies is linearly related to the amount of data involved, the calculation volume will not be very large (e.g., because per period, not a great volume of information from which to extract new text set from is generated), nor will the calculations take a long time, even if the word frequency table is updated by counting all text stored in the database(s). In some embodiments, text sets can be periodically removed from the database(s) to decrease the amount of text that needs to be counted during each generation of the word frequency table. For example, for a new period, the text sets from the oldest period can be removed from the database. In some embodiments, Scenario 1 can be used when an existing word frequency table is not available (e.g., stored).

Scenario 2: An existing word frequency table is updated based on the one or more new text sets.

After each time one or more new text sets are obtained, the frequency of each word (including keywords and non-keyword words) in each new text set is counted. An existing word frequency table that includes the previously determined frequency of each word in each text set in the database (i.e., the information of the existing word frequency table is based on original text sets) is updated based on the count results of the words in each new text set. In some embodiments, Scenario 2 can be used when an existing word frequency table is available (e.g., stored).

In various embodiments, given a generated word frequency table, the weight value of each separated and extracted keyword in each text set (new text and original text sets) currently stored in the database can be determined as follows for each keyword that is included in the database(s): the corresponding frequencies of the keyword in each of the text sets that are currently stored at the database(s) are determined from the word frequency table; a ratio based on the total number of text sets that are currently stored in the database(s) to the number of text sets that include the keyword is determined; then a corresponding weight value of the keyword in each text set is determined based on the corresponding frequencies of the keyword in each text set and the determined ratio. In some embodiments, for each text set that is stored in the database(s), a vector can be used to hold the respective weight values of all the keywords that were extracted from that text set. Some specific examples of determining the ratio and the weight values of keywords included in each text set is discussed further below.

At 208, a degree of similarity between the new text set and another text set is determined based at least in part on a weight value associated with the keyword associated with the new text set and a weight value associated with a keyword associated with the other text set.

In some embodiments, the degree of similarity of each new text set in relation to another text set that is currently stored in the database(s) can be determined. This determination includes determining the degree of similarity between any two new sets of text and also determining the degree of similarity between each new text set in relation to each original set of text stored in the database(s).

An example of determining the degree of similarity between each new text set and each other text set that is currently stored in the database(s) includes the following: composing, for each text set whose degree of similarity to another text set is to be determined, a weight vector (or some other form of data structure) that includes the respective weight value of each keyword that is extracted from that text set; for each new text set, determining the inner product between the weight vector of the new text set and each of the weight vectors corresponding to the text sets currently stored in the database(s) and obtaining the degrees of similarity between the new text set and each of the text set that is currently stored in the database(s).

Because the degrees of similarity between original text set in the database were determined in a previous iteration of process 200 (when text sets that were extracted in previous, then-current period were compared to the original text sets of the database at that time), in this current iteration of process 200, in some embodiments, the degrees of similarity are determined only between each new text set and another new text set, and/or each new text set and each original text set that is stored in the database(s). By avoiding some determinations of degrees of similarity (e.g., between two original text sets), the volume of data to be processed can be reduced.

At 210, whether the new text set is related to the other text set can be determined based at least in part on the determined degree of similarity.

After the degree of similarity is determined for each new text set and another new text set and/or each new text set and an original text set, it can be determined whether the two text sets are related or not related based on the degrees of similarity. Because in a previous period (e.g., a previous iteration so process 200), the degrees of similarity (and, in some embodiments, also relatedness) between pairs of original text sets have already been determined and stored, they do not need to be determined again in this iteration of process 200.

To determine whether a text set is related to another text set (e.g., whether a new text set is related to another new text set, whether a new text set is related to an original text set) one of the following techniques can be used, for example:

Technique 1—Setting a threshold degree of similarity value:

A threshold degree of similarity value can be set (e.g., by a system administrator) and if a degree of similarity between two text sets (e.g., a new text set and another new text set, a new text set and an original text set) meets or exceeds the threshold value, then the two text sets are determined to be related to each other; otherwise, the two text sets are determined to be not related to each other.

Technique 2—Ranking degrees of similarity and selecting a predetermined number of pairs of text sets whose degrees of similarities are ranked highest:

The degrees of similarity for all pairs of text sets (e.g., a new text set and another new text set, a new text set and an original text set) are ranked. Then, a predetermined number (e.g., as set by a system administrator) of pairs of text setswith the highest degrees of similarity are determined to be related to each other.

Identifiers associated with the relatedness of pairs of text sets are stored in the database(s). In various embodiments, one text set can be related to zero, one, or more than one other text sets.

The relatedness between pairs of text sets can be useful in various ways. For example, they can be used in making product recommendations. In this example, the acquired user published content information can be related to product information that is submitted at an electronic commerce website. Product information can include characteristics, specifications, and/or other descriptions of products that are submitted by sellers of the products. So, the extracted text from such information is also related to products. In response to a user performing an action associated with a product (e.g., clicking on an interactive web page element, purchasing a product, providing feedback on a product) at the electronic commerce website, one or more text sets associated with this product are retrieved from the database(s). Then, any text sets that was determined to be related to the text set(s) associated with this product are also retrieved from the database(s). The products that are associated with the related text are then recommended to the user (e.g., displayed by the website that feature the products to the user's web browser).

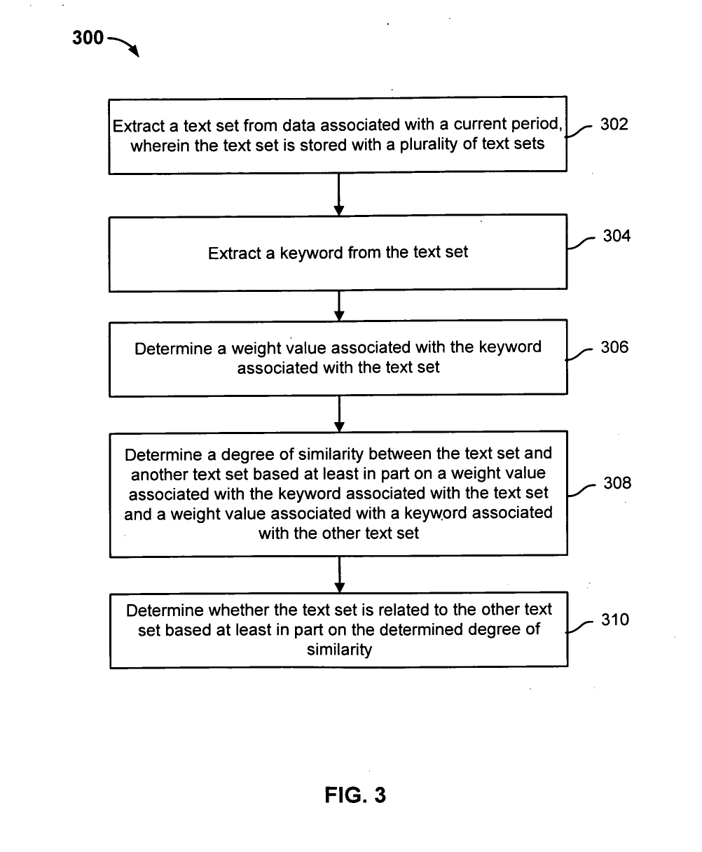

FIG. 3 is a flow diagram showing an embodiment of a process of matching text sets. In some embodiments, process 300 can be implemented at system 100. Process 300 can be used to determine the degree of similarity between any two text sets at the database(s), regardless if the two text sets are designated as two new text sets, two original text sets, or one new text set and one original text set.

At 302, a text set is extracted from data associated with a current period. In various embodiments, the text set is stored with a plurality of other text sets. 302 is similar to 202 of process, as described above. In some embodiments, the plurality of other text sets includes all the text stored at the database(s), including other new text sets (text sets that were acquired associated with the current period) and original text sets (text sets that were acquired associated with a previous period).

At 304, a keyword is extracted from the text set. 302 is similar to 202 of process, as described above.

At 306, a weight value associated with the keyword associated with the text set is determined. 306 is similar to 206 of process 200, as described above. A word frequency table can also be determined similar to the manners described in 206.

At 308, a degree of similarity between the text set and another text set of the plurality of text sets is determined based at least in part on a weight value associated with the keyword associated with the text set and a weight value associated with a keyword associated with the other text set.

In various embodiments, the degree of similarity can be determined for any pair of texts stored in the database(s). For example, the determination of the degree of similarity between any two pairs of text sets in the database includes: determining the degree of similarity between any two new text sets, determining the degrees of similarity between each new text set and each original text set currently stored in the database, and determining the degree of similarity between any two original text sets. The determination of the degree of similarity between any two text sets (e.g., one new text set and one original text set, two next text sets, or two original text sets) can include: composing, for each text set whose degree of similarity to another text set is to be determined, a weight vector (or some other form of data structure) that includes the respective weight value of each keyword that is extracted from that text set; for each text set stored in the database(s), determining the inner product between the weight vector of the text set and each of the weight vectors corresponding to each of the other text sets currently stored in the database(s) and obtaining the degrees of similarity between the text set and each of the text sets that is currently stored in the database(s)

In some embodiments, each time after the word frequency table is updated, the degrees of similarity between each pairs of text sets stored at the database(s) are determined.

At 310. whether the text set is related to the other text set can be determined based at least in part on the determined degree of similarity.

The same techniques used in 210 can be used to determine whether two text sets are related, only in 310, the pair of text sets can includes two original text sets and as well as two new text sets, or a new text set and an original text set.

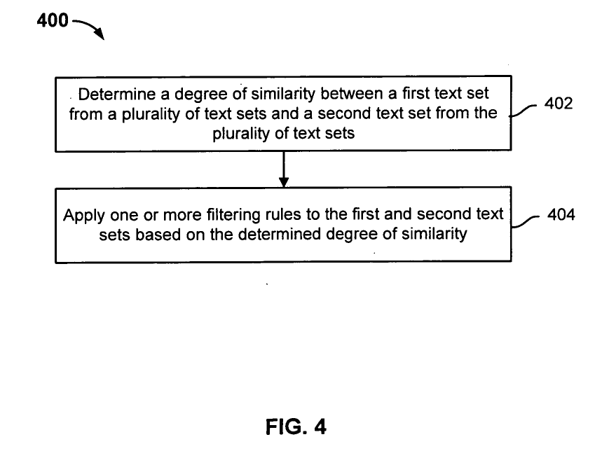

FIG. 4 is a flow diagram showing an embodiment of a process of filtering text sets. In some embodiments, process 400 can be implemented at system 100. In some embodiments, process 400 can be implemented with process 200 and/or process 300. For example, process 400 can be performed in process 200 after 208 but before 210. Also, for example, process 400 can be performed in process 300 after 308 but before 310.

At 402, a degree of similarity between a first text set from a plurality of text sets and a second text set from the plurality of text sets is determined. In various embodiments, the first and second text sets are stored at one or more databases. In various embodiments, during every period, new user published content information is acquired each period and text sets extracted from such information is stored at the database(s). The database(s) store both new text sets (text sets that are obtained during the current period) and original text sets (text sets that are obtained during a previous period). The first text set can be either a new text set or an original text set. The second text set can either be a new text set or an original text set.

If process 400 were performed in process 200, then the first and second text sets would include a new text set and either another new text set or an original text set (i.e., one of the first and second text sets is a new text set and the other is either another new text set or an original text set).

If process 400 were performed in process 300, then the first and second text sets would include two new text sets or two original text sets or a new text set and an original text set (i.e., the first and second text sets are just any two text from the database(s) that stores both new and original text).

At 404, one or more filtering rules are applied to the first and second text sets based on the determined degree of similarity.

One or more filtering rules can be set by a system administrator to eliminate certain text set that may not be as useful as determined based on their degrees of similarities with other text set in the database(s). Text sets of the database(s) can be discarded based on the one or more filtering rules. For example, the filtering rules can instruct to discard a text set if the degree of similarity between the text set and every other text set in the database(s) is below a threshold degree of similarity value.

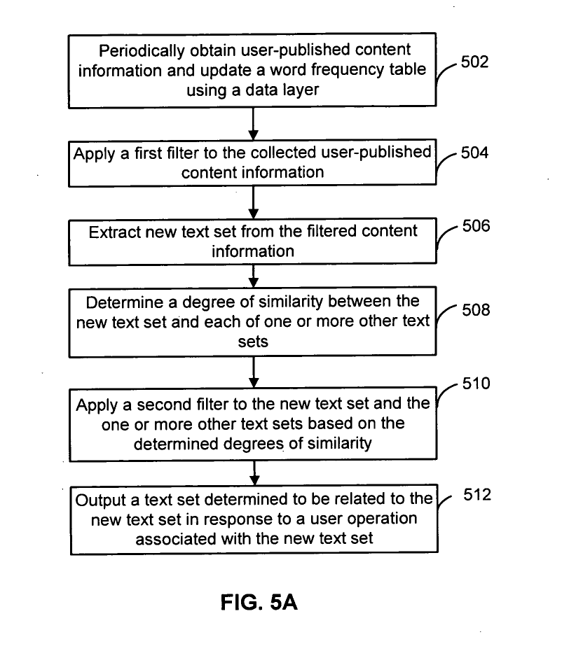

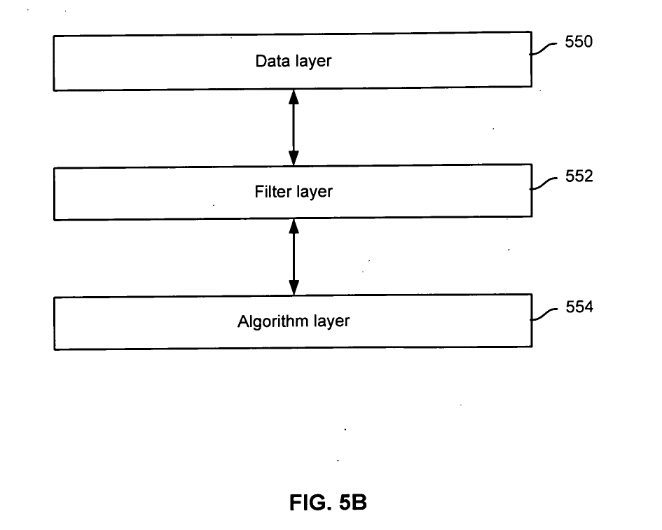

FIG. 5A is a flow diagram showing an example of a process of matching text sets. FIG. 5B is an example of an architecture with which process 500 can be implemented at least in part. Each of data layer 550, filter layer 552, and algorithm layer 554 can be implemented using one or both of software and/or hardware.

At 502, user-published content information is obtained and a word frequency table is updated, periodically.

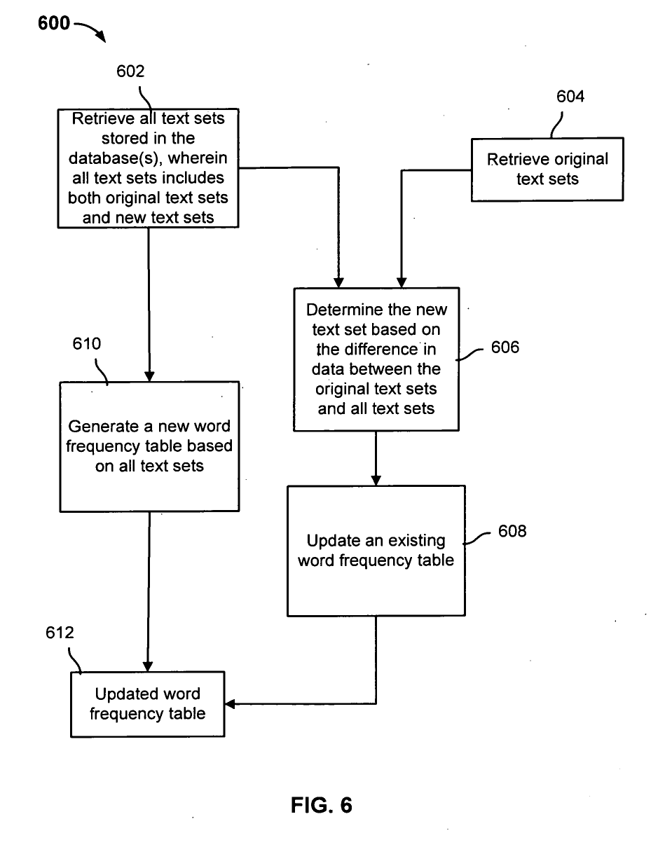

User-published content information is obtained every predetermined period and stored to one or more database(s) that store obtained content information and/or text extracted from such information. Also, the word frequency table associated with the keywords of the stored text sets is also periodically updated. In some embodiments, the word frequency table is updated after content information is obtained for each predetermined period. Also, FIG. 6, as discussed below, is an example of two techniques by which to obtain an updated word frequency table.

In various embodiments, user-published content information is obtained and a word frequency table is updated, periodically, at a data layer such data layer 550 of FIG. 5B. In various embodiments, the data layer refers to a logical set of resources that are associated with periodically obtaining content information and updating the word frequency table. For example, the data layer can include one or more databases that store content information and/or text that are extracted thereof. The data layer can provide data for data application layers, which are configured to display at least some of the data (e.g., at a user interface). In some process 500, the data layer provides input data for the algorithm layer and receives the matching determination results of the algorithm layer.

For example, the obtained user-published content information can be product information that is submitted by sellers at an electronic commerce website. The text sets that are to be extracted from such information can include text sets associated with properties of products and descriptions of products. In a specific example, assume that the text set extracted from a certain piece of product information is associated with the product of a MP3 player. Then, the text set associated the MP3 player can be used to match against other text sets associated with products that could be similar to a MP3 player.

At 504, a first filter is applied to the obtained user-published content information.

The obtained user-published content information can be filtered to remove information that may not be as interesting/useful for the purposes of matching text sets (e.g., because they are provided by unqualified users and/or are not complete). In various, embodiments, one or more filtering rules that are predetermined (e.g., by a system administrator) are applied to the obtained user-published content information to filter out (i.e., discard) the content information that is not appropriate/useful/interesting for matching text sets.

For example, a rule for filtering can instruct to filter out content information that does not include requisite content (e.g., an image of a product, complete product description). A piece of content information can be assigned a quality score based on the types and amount of content that it includes. Specifically, points can be assigned to each piece of content (e.g., images, required product specifications and descriptions) in each piece of content information. Then, if an accumulated quality score associated with a piece of content information is below a predetermined quality score threshold, then that piece of content information is discarded (e.g., not used for matching against text sets).

In another example, a rule for filtering can instruct to filter out content information that is published/submitted by unqualified users. For instance, an electronic commerce website, users (e.g., sellers) can receive ratings from other users (e.g., buyers) regarding their credibility and so for users whose credibility is below a predetermined value, then the user is determined to be unqualified and the content information (e.g., product information) published by those users will be filtered out. Examples of unqualified users could include web crawlers, robots, and even human users who are not properly contributing to the website. Also, for instance, users whose number of visits to the electronic commerce website exceeds a predetermined value can also be deemed as unqualified. This can be especially useful to exclude content information that is provided by a web crawler or robot because, sometimes, a user that is actually a web crawler or a robot tends to visit a website very frequently during a certain period of time (e.g., around the time in which it has published content information). Also, for instance, a user whose credit card information that is stored at the website is expired, and/or who has a poor credit score, and or has been inactive from the website beyond a predetermined period of time can be deemed as an unqualified user. Inactive users are users who have not conducted an operation (e.g., logged onto the website and/or have not interacted with any elements at the website) within a set period of time. The above are merely example of filtering rules, but more and/or different filtering rules can be applied in implementation.

In some embodiments, one or more filtering rules are applied to the obtained user-published content information at the filter layer such as filter layer 554 of FIG. 5B. In various embodiments, the filter layer refers to a logical set of resources that are associated with filtering out certain, if any, of the obtained user-published content information. In some embodiments, the content information that is not filtered out by the one or more filtering rules is output to the algorithm layer.

At 506, new text set is extracted from the filtered content information.

The content information that is not discarded after the application of the one or more filtering rules is processed at 506. Because the content information is obtained during the current period, a text set that is extracted from the content information is referred to as a new text set. Similar to what is described in 202 of process 200, the non-text content of the content information is not extracted. These new text sets can be stored in one or more database(s).

At 508, a degree of similarity between the new text set and each of one or more other text sets is determined.

The degree of similarity between the new text set and each of one or more other text sets (e.g., new text set or original text set) that are stored in the same one or more database(s) can be determined. A degree of similarity between two text sets can be determined based at least in part on an updated word frequency table, such as one described below and/or one described in 206 of process 200.

In various embodiments, the degree of similarity between the new text set and one or more text sets is determined at the algorithm layer such as algorithm layer 556. In various embodiments, the algorithm layer refers to a set of logical resources that are associated with using a word frequency table to compute a degree of similarity (e.g., a numerical value) between a pair of text sets. In various embodiments, the determined degrees of similarity between text sets are output back to the filter layer (e.g., filter layer 554).

Prior to determining the degree of similarity between one text set and another, each text set is to be separated into individual words and one or more keywords are to be selected among the separated words. In some embodiments, a weight value is determined for each keyword that is extracted from a text set. The keywords and their respective weight values associated with a text set will represent the text set when it is compared against another text set.

Below is an example of determining a weight value of each keyword that is extracted from each text set (e.g., new text set or original text set):

First, for each text set, determine the number of times that each keyword that is extracted from the text set appears in that text set (e.g., the frequency of a keyword in a text set).

The frequency of each keyword in a text set can be obtained through the word frequency table. The frequency of words in the word frequency table can be obtained through term frequency—inverse document frequency (TF-IDF). That is, the frequency of the ith keyword in the jth text set can be obtained from the formula below:

$${TF}_{i , j} = \frac{{f}_{i , j}}{max {f}_{z , j}} \qquad ( 1 )$$

Where f_{i,j} is the frequency of the ith keyword kᵢ in the jth text set dⱼ, max f_{z,j} expresses the maximum value of and f_{i,j}, and i and j are integers. The word frequency table is updated according to this formula, and the word frequency table can be directly queried when a determination of the frequency of a particular word is needed.

In some embodiments, the values of f_{i,j} and max f_{z,j} may be determined based on actual conditions. For example, one could set the values of f_{i,j} and max f_{z,j} to 1 to indicate that multiple occurrences of the same keyword in a text set shall be regarded as one occurrence.

Second, for each keyword in each text set, the ratio of all text sets stored in the database(s) to text sets that include the keyword is determined. For example, this ratio can be determined through the following formula:

$${IDF}_{i} = log \frac{N}{{n}_{i}} \qquad ( 2 )$$

Where N is the number of all text sets in the database(s), and nᵢ is number of text sets that include the ith keyword kᵢ.

The techniques of determining keyword frequency and the process of determining the ratios associated with the keyword do not have to occur in a particular order; they can also be implemented concurrently.

Then, based on the determined frequency of each keyword in each text set and the determined ratio as described above, the weight value of each keyword in each text set is determined. For example, the weight value of the keyword kᵢ in the text dⱼ can be determined using the following formula:

w_{i,j}=TF_{i,j}×IDFⱼ (3)

After obtaining the weight value of each keyword in each text set, a weight vector can be generated for each text set, where a weight vector could include the respective weight values of all the keywords that were extracted from that text set. This weight vector of a text is then used to determine a degree of similarity between that text set and another text set.

For example, the weight vector containing the keywords i=1, 2, . . . , k generated for text dⱼ can be represented as the following:

W(dⱼ)=(w₁ⱼ, . . . , wᵢⱼ, . . . , wₖⱼ) (4)

The degree of similarity between text set dⱼ and text set dₘ can be obtained by using, for example, the vector internal products formula, as shown below:

$$u ( {d}_{j} , {d}_{m} ) = cos ( \vec{W ( {d}_{j} )} , \vec{W ( {d}_{m} )} ) = \frac{\vec{W ( {d}_{j} )} \cdot \vec{W ( {d}_{m} )}}{{‖ W ( {d}_{j} ) ‖}_{2} \times {‖ W ( {d}_{m} ) ‖}_{2}} = \frac{{\sum }_{i = 1}^{K} {w}_{i , j} {w}_{i , m}}{\sqrt{{\sum }_{i = 1}^{k} {w}_{i , j}^{2}} \sqrt{{\sum }_{i = 1}^{k} {w}_{i , m}^{2}}} \qquad ( 5 )$$

At 510, whether the new text set is related to at least one or more other text sets is determined based on the determined degrees of similarity.

After the degrees of similarities are determined between the new text set and at least some other text set (e.g., either other new text set or original text set), whether the new text set is related to any of the other text sets is determined based on the determined degrees of similarity. In some embodiments, whether a second text set is to be related to a first text set is determined based on whether the degree of similarity between the first and second text sets meets or exceeds a predetermined threshold. In some embodiments, a second text set is determined to be related to a first text set when: a) all the text sets for which a degree of similarity has been determined with the first text set are ranked based on their respective degrees of similarity with the first text set and b) the second text set is ranked within the top N number of text sets with the highest degrees of similarity to the first text set. The purpose of this is to prevent a related association from being attached to any text set that has comparatively lower degree of similarity to the first text set.

Data that identifies the text set that are determined to be related (or matches) a particular text set are stored for that particular text set so that these relationships can be recalled later.

In various embodiments, the determination of related text set for a first text set is implemented in the filter layer or, optionally, in the algorithm layer. In some embodiments, the determination of related text set is output to the data layer.

At 512, a text set determined to be related to the new text set is output in response to a user operation associated with the new text set.

For example, if the text set were extracted from user-published content information that is associated with product information, then the text sets are also related to a product. So, at an electronic commerce website, if user operation is associated with a product that is associated with a text set, then the text sets that have been determined to be related to that text set are retrieved (e.g., using the data that identifies its related text sets). Then, the products associated with the related text sets are output (e.g., to a web browser used by the user who performed the user operation) at the electronic commerce website.

In a specific example, assume that a user (e.g., a potential buyer) is browsing a laptop product at an electronic commerce website. The laptop product is associated with a text that was previously extracted from a piece of product information regarding that laptop. The text set that was determined to be related to the text set associated with the laptop is retrieved and at least some of the products associated with the related text sets are output to the user. In this example, the related text sets could have been previously extracted from pieces of product information regarding a mouse, a keyboard, and a desktop computer. At least one of the mouse, keyboard, or desktop computers could be output to the user as a recommended product. The recommended product information can be configured for display via the data layer.

FIG. 6 is a flow diagram that shows examples of two techniques by which to obtain an updated word frequency table.

Regardless of whether the first technique (602→610→612) or the second technique (602 and 604→606→608→612) is applied, an updated word frequency table is achieved. In some embodiments, the first technique can be used when an existing (e.g., already stored) word frequency table is not available.

Using the first technique: at 602, all text sets stored in the one or more databases can be retrieved, wherein all text sets includes both new text sets (text that are obtained during the current period) and original text sets (text that are obtained from one or more previous periods). At 610, a new word frequency table is determined based on determining the frequency of each keyword extracted from each of all the text sets that were retrieved. For example, the word frequency table can include a section for each text set, the one or more keywords associated with that text set, and the corresponding frequency of each keyword in that text set. The word frequency table generated at 610 is used as the updated word frequency table at 612.

Using the second technique: in addition to retrieving all text sets at 602, at 604, original text sets (text sets that do not include the new text sets extracted during the current period) are retrieved. For example, original text sets can be stored in a database that stores only text sets obtained during previous periods as opposed to another database that stores a combination of both text sets obtained during previous periods (original text sets) and text sets obtained during the current period (new text sets) but does not differentiate between the periods with which the text sets are associated. At 606, the new text set is determined by determining a difference in data between all text sets retrieved in 602 and original text sets retrieved in 604. At 608, the frequencies of keywords extracted from the new text sets are determined and used to update an existing word frequency table (e.g., that was generated during a previous period). The existing word frequency table that was updated at 608 is used as the updated word frequency table at 612.

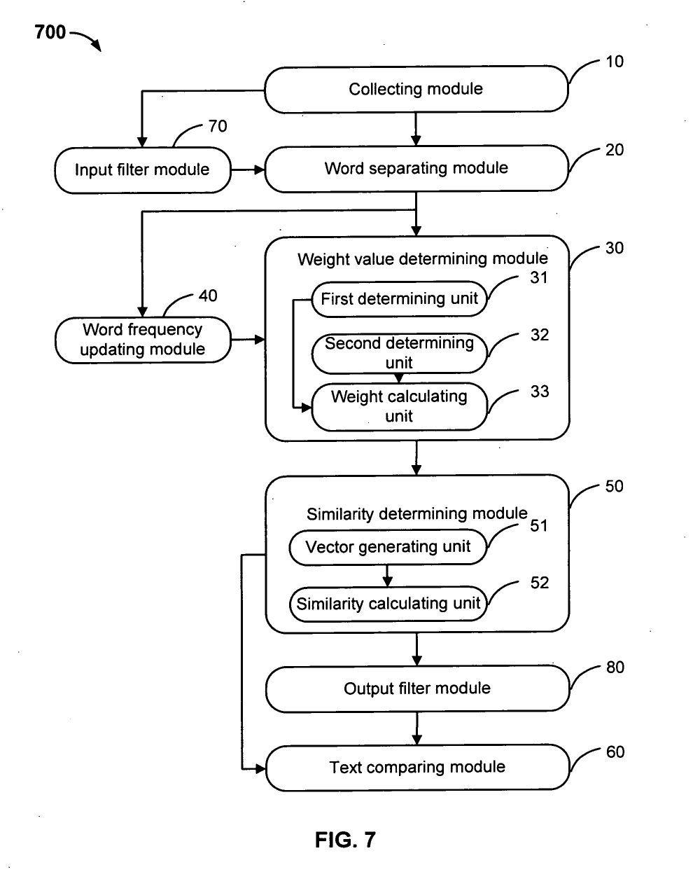

FIG. 7 is a diagram that shows an embodiment of a system for matching text sets.

System 700 includes: collecting module 10, word separating module 20, weight value determining module 30, word frequency updating module 40, degree of similarity determining module 50, and text comparing module 60.

The modules and units can be implemented as software components executing on one or more processors, as hardware such as programmable logic devices and/or Application Specific Integrated Circuits designed to perform certain functions or a combination thereof. In some embodiments, the modules and units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and units may be implemented on a single device or distributed across multiple devices.

Collecting module 10 is configured to periodically obtain user-published content information and extract, based on the content information collected in the current period, the new text sets added in the current period and store them in one or more database(s).

Word separating module 20 is configured to separate individual words in the new text sets and to extract keywords from each text set.

Weight value determining module 30 is configured to determined, based on a generated word frequency table, the weight value of each extracted keyword in each text set stored in the database(s).

In various embodiments, weight determining module 30 also includes: first determining unit 31, second determining unit 302, and weight value calculating unit 303.

First determining unit 31 is configured to determine, based on the word frequency table, the frequency of each keyword in each text set in the database(s).

Second determining unit 32 is configured to determine the ratio between the number of all text sets stored in the database and the number of text sets that include each keyword extracted from each text set.

Weight value calculating unit 33 is configured to, based on the frequency of each keyword in each text set and the ratio as determined by second determining unit 32, the weight value of each keyword in each text set.

Word frequency updating module 40 is configured to periodically update a word frequency table based on the frequency of each word in each text set in the database(s), where the text set in the database(s) include new text sets obtained from the current period and original text sets that were stored from one or more previous periods.

In various embodiments, word frequency updating module 40 is configured to: whenever a new text set is added to a database, count each word in the new text set and the frequency of each word in the original text set stored in the database, and generate a new word frequency table containing the frequencies of each word in each text set in the database; or whenever a new text set is added to a database, to count the frequency of each word in each new text set, and, based on the count results and the frequencies stored in an existing word frequency table for each word in the original text set that is already stored in the database, update the existing word frequency table to include the frequencies of each word in each text set in the database (which now includes both original and new text sets).

Similarity determining module 50 is configured to, based on the weight values determined for each keyword in each text set in the database(s), determine the degree of similarity between each new text set and each other text set in the database. In some embodiments, similarity determining module 50 is also configured to determine the degree of similarity between any two text sets (e.g., two new text sets, two original text sets, and one new text set and one original text set) in the database.

In some embodiments, similarity determining module 50 also includes vector generating unit 51 and similarity calculating unit 52.

Vector generating unit 51 is configured to generate weight vectors using the respective weight value of each keyword in each text set whose degree of similarity with another text set is to be determined.

Similarity calculating unit 52 is configured to determine the weight vector of each new text set and the inner products between the weight vectors of everyone two text sets stored in the database(s). Similarity calculating unit 52 is also configured to obtain the degrees of similarity between the new text set and each other text set that is stored in the database; or, for each text set stored in the database(s), to determine the weight vector of the text set and the inner products of the weight vectors of each pair of text sets that are stored in the database, and to obtain the degree of similarity between each pair of text sets.

Text comparing module 60 is configured to determine, based on the determined degrees of similarity, the related text sets for each text set that is stored in the database(s).

In some embodiments, text comparing module 60 described is configured to: for each text set whose related text sets are to be determined, determine a related text set for at least one text set stored in the database having a degree of similarity greater than or greater than or equal to a set threshold value; or for each text set whose related text set are to be determined, determine based on the ranked order of degrees of similarity between the text set in the database and the text set whose related text sets are to be determined, a set quantity of text set that are stored in the database and have higher degrees of similarity to be the related text sets for the text set whose related text sets are to be determined.

In some embodiments, text comparing module 60 described also includes: input filter module 70 configured to filter, based on a predetermined filtering rule, the user-published content information collected in the current period, and based on the filtered content information, to extract the new text sets added in the current period and to input the new text sets into word separating module 20.

Input filter unit 70 is configured to filter, based on whether the quality of the content information complies with a predetermined quality evaluation value and/or whether the user that published the content information has been determined to be a qualified user.

In some embodiments, the text comparing device 60 also includes: output filtering module 80 configured to determine, based on the degree of similarity of each text set in the database to each new text set, or the degree of similarity calculated between any two text sets in the database, to remove text sets whose degree of similarity to the new text sets whose related text sets are to be determined or to text sets stored in the database is less than a predetermined threshold value, or to remove text sets which are less similar to the new text sets whose related text sets are to be determined or to text sets stored in the database, and providing the text sets to text comparing module 60. Text comparing module 60 then, based on the filtered text sets, is configured to determine the related text sets for the new text set or any text sets stored in the database.

The above-described text matching techniques provided by the embodiments of the present application may be implemented through either software or hardware. For example, they can be implemented through C, a Linux operating system, an application distributed group, such as a cluster, Hadoop (a distributed system architecture) group, or other hardware. The described techniques can be used in various text matching processes, e.g., applied for matching of product-related text data in resource (sourcing) platforms used in electronic transactions. In this way, related products (e.g., product recommendations) can be supplied to users.

Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
extract a text set from data associated with a current period;
store the text set with a plurality of text sets;
extract a keyword from the text set;
determine a weight value associated with the keyword associated with the text set;
determine a degree of similarity between the text set and another text set based at least in part on a weight value associated with the keyword associated with the text set and a weight value associated with a keyword associated with the other text set; and
determine whether the text set is related to the other text set based at least in part on the determined degree of similarity;
a memory coupled to the processor and configured to provide the processor with instructions.

2. The system of claim 1, wherein the plurality of text sets includes one or more original text sets and one or more new text sets, wherein original text sets are associated with one or more previous periods and new text sets are associated with a current period.

3. The system of claim 1, wherein the processor is further configured to update a word frequency table that includes frequencies corresponding to each of one or more words, wherein a frequency is associated with a number of times a word appears within a particular text set of the plurality of text sets.

4. The system of claim 3, wherein the processor is further configured to use frequencies of the word frequency table corresponding to one or more keywords associated with the text set to generate a weight value corresponding to each of the one or more keywords.

5. The system of claim 1, wherein the text set comprises a new text set and the other text set comprises an original text set.

6. The system of claim 1, wherein the text set comprises a new text set and the other text set comprises another new text set.

7. The system of claim 1, wherein to determine a degree of similarity between the text set and the other text set, one or more weight values corresponding to one or more keywords extracted from the text set are compared with one or more weight values corresponding to one or more keywords extracted from the other text set.

8. The system of claim 1, wherein to determine whether the text set is related to the other text set is based at least in part on whether the degree of similarity at least meets a predetermined threshold value.

9. The system of claim 1, wherein to determine whether the text set is related to the other text set is based at least in part on whether the degree of similarity is among a predetermined number of highest ranked degrees of similarity associated with the text set and determined degrees of similarities associated with other text sets.

10. The system of claim 1, wherein the processor is further configured to determine a degree of similarity between a first original text set and a second original text set of the plurality of text sets.

11. The system of claim 1, wherein the text set is associated with a first product and wherein a related text set is associated with a second product, wherein the processor is further configured to output the second product as a recommended product in response to receiving a user operation associated with the first product.

12. A method, comprising:
extracting a text set from data associated with a current period;
storing the text set with a plurality of text sets;
extracting a keyword from the text set;
determining a weight value associated with the keyword associated with the text set;
determining a degree of similarity between the text set and another text set based at least in part on a weight value associated with the keyword associated with the text set and a weight value associated with a keyword associated with the other text set; and
determining whether the text set is related to the other text set based at least in part on the determined degree of similarity.

13. The method of claim 12, further comprising updating a word frequency table that includes frequencies corresponding to each of one or more words, wherein a frequency is associated with a number of times a word appears within a particular text set of the plurality of text sets.

14. The method of claim 13, further comprising using frequencies of the word frequency table corresponding to one or more keywords associated with the text set to generate a weight value corresponding to each of the one or more keywords.

15. The method of claim 12, wherein determining a degree of similarity between the text set and the other text set, one or more weight values corresponding to one or more keywords extracted from the text set are compared with one or more weight values corresponding to one or more keywords extracted from the other text set.

16. The method of claim 12, wherein determining whether the text set is related to the other text set is based at least in part on whether the degree of similarity at least meets a predetermined threshold value.

17. The method of claim 12, wherein determining whether the text set is related to the other text set is based at least in part on whether the degree of similarity is among a predetermined number of highest ranked degrees of similarity associated with the text set and determined degrees of similarities associated with other text set.

18. The method of claim 12, further comprising determining a degree of similarity between a first original text set and a second original text set of the plurality of text sets.

19. The method of claim 12, wherein the text set is associated with a first product and wherein a related text set is associated with a second product, further comprising outputting the second product as a recommended product in response to receiving a user operation associated with the first product.

20. A computer program product, the computer program product being embodied in a computer readable medium and comprising computer instructions for:
extracting a text set from data associated with a current period;
storing the text set with a plurality of text sets;
extracting a keyword from the text set;
determining a weight value associated with the keyword associated with the text set;
determining a degree of similarity between the text set and another text set based at least in part on a weight value associated with the keyword associated with the text set and a weight value associated with a keyword associated with the other text set; and
determining whether the text set is related to the other text set based at least in part on the determined degree of similarity.
